(19) United States
(12) Patent Application Publication
(10) Pub. No.: US 2010/0328525 A1
(43) Pub. Date: Dec. 30, 2010

(54) CAMERA MODULE

(75) Inventors: Soo-bong LEE, Changwon-city (KR); Ha-cheon JEONG, Changwon-city (KR); Min-kyu KIM, Changwon-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG TECHWIN CO., LTD., Changwon-city (KR)

(21) Appl. No.: 12/760,959

(22) Filed: Apr. 15, 2010

(30) Foreign Application Priority Data
Jun. 30, 2009 (KR) 10-2009-0059295

(51) Int. Cl. H04N 5/225

(52) U.S. Cl. 348/374; 348/E05.027

(57) ABSTRACT

A camera module and a method of manufacturing the camera module are provided. The camera module includes a substrate having an opening through which light passes, a circuit pattern for transmitting an electrical signal, and first and second terminals connected to the circuit pattern; an image sensor combined with the substrate so as to receive the light through the opening, and electrically connected to the first terminals; a lead frame disposed around the image sensor and electrically connected to the second terminals of the substrate; a housing combined on a surface of the substrate opposite to another surface on which the image sensor and the lead frame are combined; and a lens disposed in the housing.

### CROSS-REFERENCE TO RELATED PATENT APPLICATION

This application claims priority from Korean Patent Application No. 10-2009-0059295, filed on Jun. 30, 2009, in the Korean Intellectual Property Office, the disclosure of which is incorporated herein in its entirety by reference.

### BACKGROUND

1. Field of the Invention

Apparatuses and methods consistent with the present inventive concept relate to a camera module, and more particularly, to an ultra thin camera module capable of easily mass-produced.

2. Description of the Related Art

Camera modules are mounted on currently popular devices such as mobile phones, personal digital assistants (PDAs), notebook computers, rear-view cameras of cars and door security cameras.

As demands for portable communication devices on which camera modules are mounted, e.g., camera phones, are explosively increased, demands for thinner and smaller camera modules are also increased. Camera modules are required to have very small sizes in consideration of small portable devices and aesthetic exteriors at places where devices using the camera modules are set. In order to manufacture a small and thin camera module, a small and thin image sensor needs to be used in the camera module.

A camera module mounted on a small portable device includes an image sensor and a lens housing combined on a surface of the image sensor. The image sensor includes an image sensor chip, a printed circuit board (PCB) electrically connected to the image sensor chip and for transmitting a captured image signal to an external circuit. At least one lens and an infrared filter are mounted on the lens housing.

A general camera module includes an image sensor chip mounted on a substrate such as a PCB, and is manufactured by electrically connecting bonding pads of the image sensor chip to connection pads of the substrate by using a wire bonding method. However, in an existing wire bonding method, a package may not easily have a small thickness due to a loop height of wire (a distance between a surface of a chip to the maximum height of wire bonded on the chip).

Alternatively, a flip chip bonding method is also used to manufacture a small and thin camera module. While the above-described wire bonding method generally uses a chip on board (COB) technology for mounting an image sensor chip on a hard printed circuit board (HPCB), the flip chip bonding method uses a chip on film (COF) technology for mounting an image sensor chip on a flexible printed circuit board (FPCB).

A flip chip bonding method is used to manufacture a thinner camera module in comparison to a wire bonding method, but does not greatly reduce the thickness of the camera module. In more detail, an image sensor chip and a PCB are sequentially stacked in a camera module manufactured by using a flip chip bonding method, and thus, the camera module may not have a thickness less than a sum of the thicknesses of the image sensor chip and the PCB.

Also, since a general flip chip package is manufactured by adhering one image sensor on one PCB, a lot of time is required to manufacture a camera module, a production yield rate is low, and thus mass-production of the camera module is restricted.

### SUMMARY

Exemplary embodiments of the present inventive concept provide an ultra thin camera module.

The exemplary embodiments of the present inventive concept also provide a camera module capable of easily mass-produced.

According to an aspect of an exemplary embodiment, there is provided a camera module including a substrate having an opening through which light passes, a circuit pattern for transmitting an electrical signal, and first and second terminals connected to the circuit pattern; an image sensor combined with the substrate so as to receive the light through the opening, and electrically connected to the first terminals; a lead frame disposed around the image sensor and electrically connected to the second terminals of the substrate; a housing combined on a surface of the substrate opposite to another surface on which the image sensor and the lead frame are combined; and a lens disposed in the housing.

The substrate may be a flexible printed circuit board (FPCB).

The substrate may be another lead frame sealed with a resin.

The camera module may further include an optical filter disposed on the surface of the substrate opposite to the other surface on which the image sensor and the lead frame are combined, so as to cover the opening.

The image sensor may include terminal pads corresponding to the first terminals and may be combined with the substrate by using a flip chip bonding method or a surface mount technology (SMT) to bond the terminal pads with the first terminals.

The lead frame may include leads corresponding to the second terminals and may be combined with the substrate by using a flip chip bonding method or an SMT to bond the leads with the second terminals.

The lead frame may further include a mold unit filled in spaces between the leads.

The camera module may further include solder bumps adhered to the leads on a surface of the lead frame opposite to another surface that faces the substrate.

According to an aspect of an exemplary embodiment, there is provided a method of manufacturing a camera module, the method including: providing a substrate having an opening through which light passes, a circuit pattern for transmitting an electrical signal, and first and second terminals connected to the circuit pattern; combining an image sensor with the substrate by electrically connecting terminal pads of the image sensor to the first terminals, the image sensor receiving the light passing through the opening to convert optical information of the light to an electrical signal; disposing a lead frame, having an opening in a center, around the image sensor so that the lead frame accommodates the image sensor in the opening in a horizontal direction, and electrically connecting the lead frame to the second terminals of the substrate; disposing a housing on a surface of the substrate opposite to another surface on which the image sensor and the lead frame are combined; and disposing a lens in the housing and above the image sensor.

### BRIEF DESCRIPTION OF THE DRAWINGS

The above and other aspects of the present invention will become more apparent by describing in detail exemplary embodiments thereof with reference to the attached drawings in which:

FIG. 1 is a schematic cross-sectional view of a camera module, according to an exemplary embodiment;

FIG. 2 is an exploded bottom perspective view of the camera module illustrated in FIG. 1, according to an exemplary embodiment;

FIG. 3 is a cross-sectional view of the lead frame illustrated in FIG. 1 when solder bumps are combined, according to an exemplary embodiment;

FIG. 4 is a cross-sectional view for describing a process of combining solder bumps with the lead frame illustrated in FIG. 3, according to an exemplary embodiment;

FIG. 5 is a cross-sectional view for describing a process of combining an image sensor with a substrate of the camera module illustrated in FIG. 1, according to an exemplary embodiment;

FIG. 6 is a cross-sectional view for describing a process of combining a lead frame with the substrate illustrated in FIG. 5, according to an exemplary embodiment;

FIG. 7 is a cross-sectional view for describing a process of combining an optical filter with the substrate illustrated in FIG. 6, according to an exemplary embodiment;

FIG. 8 is a cross-sectional view for describing a process of combining a housing with the substrate illustrated in FIG. 7, according to an exemplary embodiment;

FIG. 9 is a plan view of an example of a lead frame strip used to manufacture the camera module illustrated in FIG. 1, according to an exemplary embodiment; and

FIG. 10 is a plan view of an example of a substrate strip used to manufacture the camera module illustrated in FIG. 1, according to an exemplary embodiment.

### DETAILED DESCRIPTION OF EXEMPLARY EMBODIMENTS

Hereinafter, the present inventive concept will be described in detail by explaining exemplary embodiments with reference to the attached drawings.

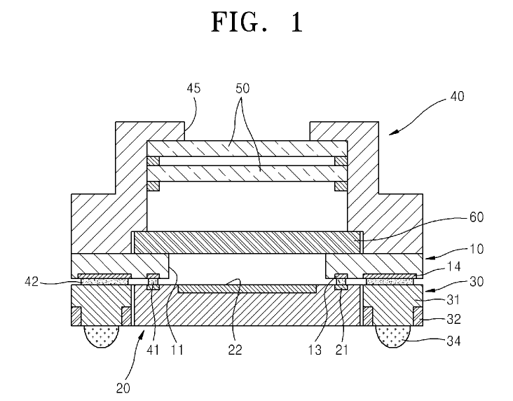

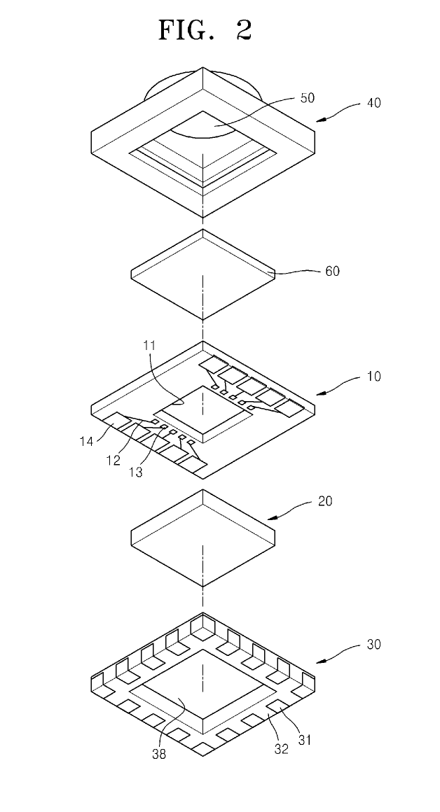

FIG. 1 is a schematic cross-sectional view of a camera module, according to an exemplary embodiment. FIG. 2 is an exploded bottom perspective view of the camera module illustrated in FIG. 1, according to an exemplary embodiment.

Referring to FIGS. 1 and 2, the camera module includes a substrate 10 including an opening 11, an image sensor 20 combined with the substrate 10, a lead frame 30 disposed around the image sensor 20 and combined with the substrate 10, a housing 40 disposed opposite to or above the image sensor 20 and combined with the substrate 10, and a lens 50 accommodated in the housing 40.

The image sensor 20 is a semiconductor device for converting optical information into an electrical signal, and may be, for example, a charge coupled device (CCD) image sensor or a complementary metal oxide semiconductor (CMOS) image sensor.

The image sensor 20 includes a light-receiving area 22 for receiving light and converting the light into an electrical signal, and terminal pads 21 for electrically connecting the light-receiving area 22 to an external device, on a front surface of the image sensor 20. The terminal pads 21 are formed around the light-receiving area 22, and are electrically connected to first terminals 13 of the substrate 10 to be described later.

The substrate 10 includes an opening 11 through which the light passes, a circuit pattern 12 for transmitting the electrical signal, and the first terminals 13 and second terminals 14 connected to the circuit pattern 12. The first terminals 13 are electrically connected to the terminal pads 21 of the image sensor 20. If necessary, a passive device such as a capacitor may be mounted on a front surface of the substrate 10.

The substrate 10 may be a hard printed circuit board (HPCB) or a flexible printed circuit board (FPCB). The substrate 10 is not limited to a printed circuit board (PCB) and may be various elements including the circuit pattern 12 for implementing the first and second terminals 13 and 14. For example, the substrate 10 may be formed by using a lead frame used in a quad flat no-lead (QFN) package. When the substrate 10 is formed by using a lead frame, empty spaces of the lead frame may be filled or sealed with a resin so as to ensure stable supporting performance.

In general, a wire bonding method is used to electrically connect an image sensor to a PCB. Wire bonding refers to a process of electrically connecting terminals to each other by using conductive wires formed of a metallic material such as copper (Cu) or gold (Au). However, if the wire bonding method is used, due to a loop height, a package may not be easily formed in a small thickness.

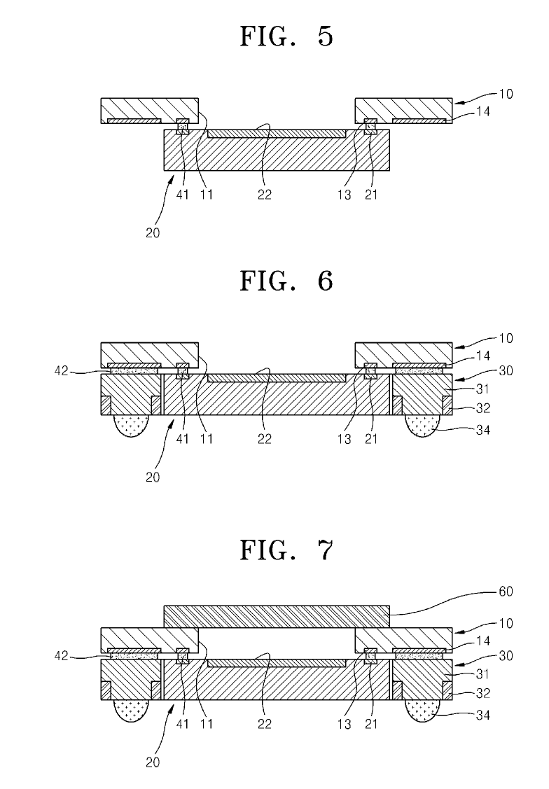

FIG. 5 is a cross-sectional view for describing a process of combining the image sensor 20 with the substrate 10 of the camera module illustrated in FIG. 1, according to an exemplary embodiment;

Referring to FIG. 5, the substrate 10 and the image sensor 20 may be electrically connected to each other by using a flip chip bonding method or a surface mount technology (SMT).

The flip chip bonding method refers to a technology of mounting a bare die itself on a circuit board without packaging a semiconductor chip, by forming bumps on the semiconductor chip and electrically connecting the bumps to connection pads printed on a PCB.

The SMT refers to a method of adhering surface mounted components (SMCs), which are directly mountable on a surface of a circuit board, on an electronic circuit.

If the flip chip bonding method or the SMT is used as an electrical connection method, the size and thickness of a package may be reduced in comparison to a wire bonding method, input/output terminals may be disposed anywhere on a chip, and processing and manufacturing costs may be reduced. Also, flip chip packages manufactured by using the flip chip bonding method may have fast electrical properties and excellent thermal performances.

For example, in the flip chip bonding method, bumps are formed on the terminal pads 21 of the image sensor 20 and an anisotropic conductive film (ACF) 41 is laminated on the image sensor 20 so as to cover the bumps. After that, the image sensor 20 is combined on the substrate 10.

When the image sensor 20 is combined with the substrate 10 by using the flip chip bonding method, the image sensor 20 and the substrate 10 may be bonded using a conductive material formed between the terminal pads 21 of the image sensor 20 and the first terminals 13 of the substrate 10. In addition to the ACF 41, the conductive material may be various bonding materials having conductivity such as an epoxy containing silver (Ag) or an anisotropic conductive paste (ACP). Alternatively, a bonding material used in the flip chip bonding method may also be a non-conductive paste (NCP).

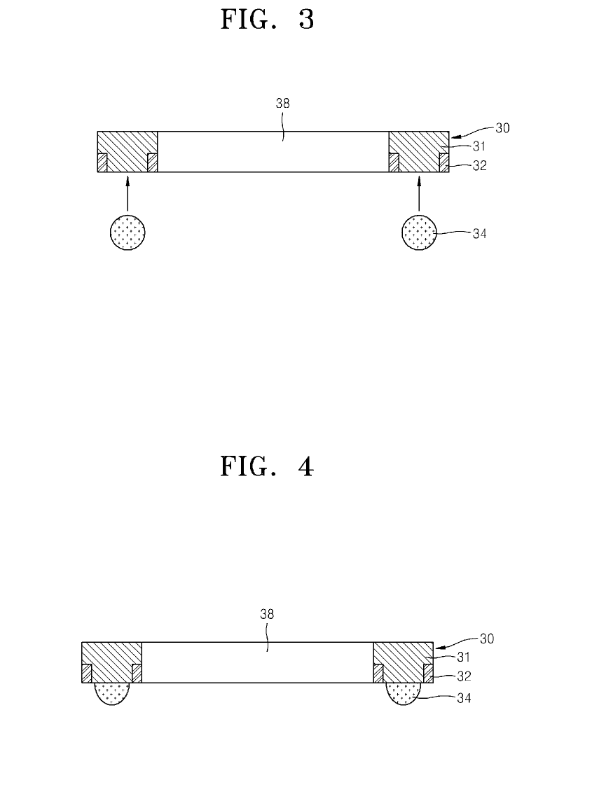

FIG. 3 is a cross-sectional view for describing a process of manufacturing the lead frame 30 of the camera module illustrated in FIG. 1, according to an exemplary embodiment. FIG. 4 is a cross-sectional view of the lead frame 30 illustrated in FIG. 3 when solder bumps 34 are combined, according to an exemplary embodiment.

Referring to FIGS. 1, 3 and 4, the lead frame 30 is disposed around the image sensor 20 and electrically connected to the second terminals 14 of the substrate 10. The lead frame 30 includes leads 31 corresponding to the second terminals 14 of the substrate 10, and a mold unit 32 filled in spaces between the leads 31. The leads 31 of the lead frame 30 contain an electrically conductive metallic material such as Cu and the mold unit 32 contains a curable conductive material such as an epoxy resin.

A die pad region formed at the center of the lead frame 30 is removed so as to accommodate the image sensor 20. When the die pad region is removed, as illustrated in FIG. 2, the opening 38 for accommodating the image sensor 20 is formed at the center of the lead frame 30. The solder bumps 34 may be formed under the lead frame 30 so as to connect the camera module to an external control circuit board.

FIG. 6 is a cross-sectional view for describing a process of combining the lead frame 30 with the substrate 10 illustrated in FIG. 5, according to an exemplary embodiment.

Referring to FIG. 6, after the substrate 10 and the image sensor 20 are combined, the lead frame 30 may be combined with the substrate 10. The lead frame 30 functions as terminals for connecting the image sensor 20 and the substrate 10 to an external device. The lead frame 30 is disposed outside the image sensor 20 so as to surround the image sensor 20, and may be electrically connected to the second terminals 14 of the substrate 10.

Like the image sensor 20, the lead frame 30 may also be connected to the substrate 10 by using a flip chip bonding method. That is, the lead frame 30 is connected to the substrate 10 by forming an electrically conductive material such as an ACF 42 between the leads 31 and the second terminals 14. In addition to the ACF 42, the conductive material may be various bonding materials having conductivity such as an epoxy containing Ag.

FIG. 7 is a cross-sectional view for describing a process of combining an optical filter 60 with the substrate 10 illustrated in FIG. 6, according to an exemplary embodiment.

Referring to FIG. 7, the optical filter 60 may be combined on a surface of the substrate 10 opposite to the surface on which the image sensor 20 is combined, so as to cover the opening 11. That is, the optical filter 60 is disposed between the housing 40 and the substrate 10. The optical filter 60 blocks infrared rays incident into the housing 40 not to reach the image sensor 20 and prevents incident light from being reflected. For this, an infrared cut coating may be formed on a front surface of the optical filter 60 and an anti-reflection coating may be formed on a rear surface of the optical filter 60.

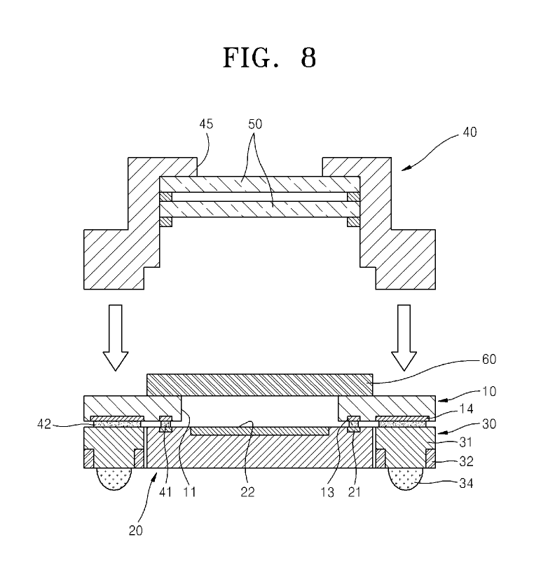

FIG. 8 is a cross-sectional view for describing a process of combining the housing 40 with the substrate 10 illustrated in FIG. 7, according to an exemplary embodiment.

Referring to FIG. 8, when the housing 40 is combined on the substrate 10 after the image sensor 20 and the lead frame 30 are fixed on the substrate 10, the camera module is completed.

The housing 40 includes an opening 45 and is combined on a front surface of the substrate 10. A lens 50 is disposed in the housing 40. The opening 45 of the housing 40 is open forward such that light in front of the camera module is incident toward the light-receiving area 22 of the image sensor 20. The lens 50 may be directly combined with the housing 40 as illustrated in FIG. 8 or may be indirectly combined with the housing 40 by using a barrel that surrounds and supports the lens 50. As the housing 40 is combined on the front surface of the substrate 10, components of the image sensor 20 and the substrate 10 are protected.

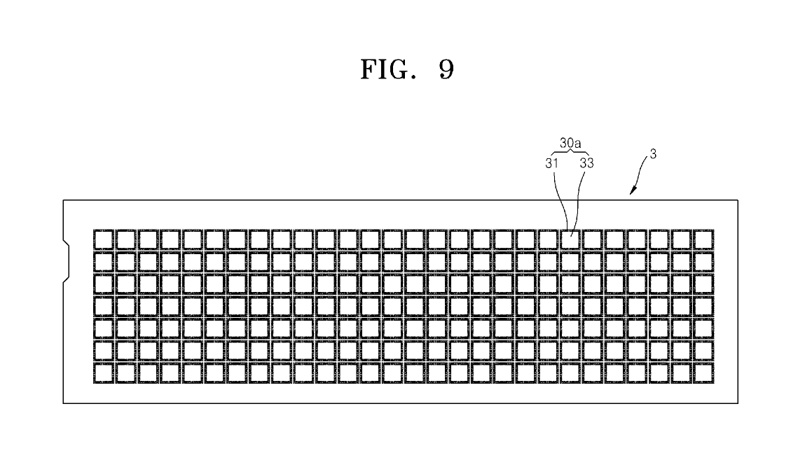

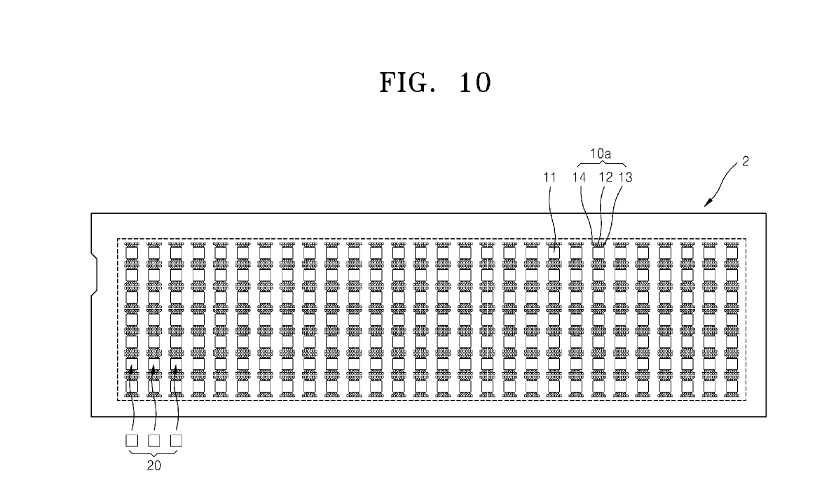

FIG. 9 is a plan view of an example of a lead frame strip used to manufacture the camera module illustrated in FIG. 1, according to an exemplary embodiment. FIG. 10 is a plan view of an example of a substrate strip used to manufacture the camera module illustrated in FIG. 1, according to an exemplary embodiment.

Substrates and lead frames are manufactured in units of a strip in which a plurality of pattern units for manufacturing camera modules are connected in rows and columns. In a method of manufacturing substrates and lead frames in units of a strip, pattern units are disposed in rows and columns so as to form a matrix, and camera modules may be mass-produced by mounting the image sensor 20 on each of the pattern units.

Referring to FIG. 9, in a lead frame strip 3, the leads 31 and a die pad region 33 form one lead frame pattern 30a and the same lead frame pattern 30a is repeated in horizontal and vertical directions.

Referring to FIG. 10, in a substrate strip 2, the opening 11, the first and second terminals 13 and 14 disposed around the opening 11, and the circuit pattern 12 form one substrate pattern 10a, and the same substrate pattern 10a is repeated in horizontal and vertical directions.

The lead frame pattern 30a and the substrate pattern 10a have sizes corresponding to each other and are disposed at locations corresponding to each other. Accordingly, the image sensors 20 are mounted on the substrate strip 2 by using a flip chip bonding method so as to cover the openings 11 of the substrate strip 2 and the lead frame strip 3 from which the die pad regions 33 are removed is combined with the substrate strip 2, thereby completing assemblies of the substrate 10, the image sensor 20 and the lead frame 30 as illustrated in FIG. 6.

Since the image sensor 20 and the lead frame 30 are combined with the substrate 10 by using a flip chip bonding method, an ultra thin camera module may be easily mass-produced.

As described above, according to the exemplary embodiments of the present inventive concept, an image sensor and a lead frame around the image sensor may be combined with a substrate by using a flip chip bonding method or an SMT, and thus, an ultra thin camera module may be manufactured. Also, lead frames and substrates may be manufactured by using strips on which a plurality of circuit patterns are sequentially formed and thus camera modules may be mass-produced.

A large number of technologies are developed to manufacture ultra-thin camera modules. For example, a method of bonding solder balls on a terminal pad of an image sensor and connecting the image sensor to a circuit substrate by using the solder balls is used. However, in this method, an area for the solder balls is large so as to increase the size of a camera module, a reflow solution of the solder balls permeates into the image sensor so as to damage the image sensor, and a grinding process has to be performed after the solder balls are bonded on the terminal pad of the image sensor. On the other hand, a camera module according to the exemplary embodiments of the present inventive concept use a lead frame, and thus, the width of an area for combining a terminal pad of an image sensor with an external device may be greatly reduced. Accordingly, a chip-scale design may be allowed, damage of the image sensor due to permeation of a reflow solution may be prevented, and a grinding process may not be required.

While the present inventive concept has been particularly shown and described with reference to the exemplary embodiments thereof, it will be understood by those of ordinary skill in the art that various changes in form and details may be made therein without departing from the spirit and scope of the present invention as defined by the following claims.

What is claimed is:

1. A camera module comprising:
a substrate comprising an opening through which light passes, a circuit pattern for transmitting an electrical signal, and first and second terminals connected to the circuit pattern;
an image sensor combined with the substrate so as to receive the light through the opening, and electrically connected to the first terminals;
a lead frame disposed around the image sensor and electrically connected to the second terminals of the substrate;
a housing combined on a surface of the substrate opposite to another surface on which the image sensor and the lead frame are connected; and
a lens disposed in the housing.

2. The camera module of claim 1, wherein the substrate is a flexible printed circuit board (FPCB).

3. The camera module of claim 1, wherein the substrate is another lead frame sealed with a resin.

4. The camera module of claim 1, further comprising an optical filter disposed on the surface of the substrate opposite to the other surface on which the image sensor and the lead frame are combined, so as to cover the opening.

5. The camera module of claim 1, wherein the image sensor comprises terminal pads corresponding to the first terminals of the substrate, and is combined with the substrate by using a flip chip bonding method or a surface mount technology (SMT) to bond the terminal pads with the first terminals of the substrate.

6. The camera module of claim 1, wherein the image sensor comprises terminal pads and first conductive films disposed on the terminal pads, and
wherein the terminal pads are connected to the first terminals of the substrate through the first conductive films.

7. The camera module of claim 6, wherein the first conductive films comprise anisotropic conductive films.

8. The camera module of claim 6, wherein the lead frame comprises leads and second conductive films disposed on the leads, and
wherein the leads are connected to the second terminals of the substrate through the second conductive films.

9. The camera module of claim 8, wherein the first and second conductive films comprise anisotropic conductive films.

10. The camera module of claim 1, wherein the lead frame comprises leads corresponding to the second terminals and is combined with the substrate by using a flip chip bonding method or an SMT to bond the leads with the second terminals.

11. The camera module of claim 10, wherein the lead frame further comprises a mold unit filled in spaces between the leads.

12. The camera module of claim 11, further comprising solder bumps adhered to the leads on a surface of the lead frame opposite to another surface that is connected to the substrate.

13. The camera module of claim 1, wherein the lead frame comprises leads and conductive films disposed on the leads, and
wherein the leads are connected to the second terminals of the substrate through the conductive films.

14. The camera module of claim 13, wherein the conductive films comprise anisotropic conductive films.
